(19) United States
(12) Patent Application Publication
(10) Pub. No.: US 2017/0337831 A1
(43) Pub. Date: Nov. 23, 2017

(54) METHOD AND SYSTEM FOR COLLISION AVOIDANCE AND ENVIRONMENT SENSING FOR A ROBOTIC SYSTEM

(71) Applicant: Converge Industries, Co., San Francisco, CA (US)

(72) Inventors: David J. Moore Pitman, Boulder, CO (US); Paul W. Quimby, Boulder, CO (US); Robert D. Corona, Boulder, CO (US)

(21) Appl. No.: 15/599,303

(22) Filed: May 18, 2017

Related U.S. Application Data
(60) Provisional application No. 62/338,033, filed on May 18, 2016.
(60) Provisional application No. 62/338,036, filed on May 18, 2016.
(60) Provisional application No. 62/338,039, filed on May 18, 2016.
(60) Provisional application No. 62/338,051, filed on May 18, 2016.

(51) Int. Cl. G08G 5/04; G08G 5/00

(52) U.S. Cl. CPC G08G 5/045; G08G 5/0069; G08G 5/0086

(57) ABSTRACT

One variation of a method for facilitating integration of user input and autonomous operations of a robotic system includes: storing a set of constraints of the robotic system; storing a model of an environment in which the robotic system is to operate; determining whether the robotic system can successfully perform operations specified by a user based on the constraints of the robotic system and the model of the environment; and, in response to determining that the robotic system cannot successfully perform the operations, modifying the operations so that the modified operations can be performed by the robotic system; and generating a set of commands for the robotic system based on the modified operations.

### CROSS-REFERENCE TO RELATED APPLICATIONS

This Application claims the benefit of U.S. Provisional Application No. 62/338,033, filed on 18 May 2016, U.S. Provisional Application No. 62/338,036, filed on 18 May 2016, U.S. Provisional Application No. 62/338,039, filed on 18 May 2016, and U.S. Provisional Application No. 62/338,051, filed on 18 May 2016, all of which are incorporated in their entireties by this reference.

### TECHNICAL FIELD

This invention relates generally to the field of unmanned aerial vehicles and more specifically to a new and useful method and system for collision avoidance and environment sensing for a robotic system in the field of unmanned aerial vehicles.

### BRIEF DESCRIPTION OF THE FIGURES

FIG. 1 is a flowchart representation of a first robotic system;

FIG. 2 is a flowchart representation of one variation of the robotic system; and

FIG. 3 is a graphical representation of the robotic system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Robotic System

In this disclosure, the term “robot” can refer to any electrical, mechanical, or combined system, which can perform operations in a partially or fully automated fashion. Robots can include a stand-alone system or part of a large system. Robots can include, but are not limited to, drones, land surface vehicles, water surface vehicles, submarines, and subterranean vehicles or machines.

At present, robots are increasingly being used to perform tasks that were once performed by humans. Existing robotic systems, however, either give complete operational control to a human operator or rely heavily on autonomous control (e.g., autopilot). When given the ability to fully control a robot, a human operator can be highly susceptible to causing error. This is due to the cognitive workload, rapidly changing operating conditions, and human perception. These errors could result in damage to equipment, robots, and/or humans. Fully autonomous robotic systems can be better equipped to operate safely, but could be unable to effectively perform many tasks alone, as they do not have the knowledge or intuition of an experienced human operator.

Embodiments of the present invention solve the aforementioned problems by fusing an operator's intent and interactions with the autonomous behavior of a robotic system 100. From the operator's point of view, they are directly controlling the robotic system 100. In reality, the operator's inputs are processed by an artificial intelligence (AI) module, which interprets the input commands and mathematically alters the commands as needed, and passes the processed commands to the robotic system 100. The final instructions sent to the robotic system 100 can include behavioral actions generated by the AI module, instead of or in additional to modification of the human input.

Note that the AI module for processing operator input commands can be based on software, hardware, or a combination of both. Furthermore, the AI module can be implemented on a specialized computer system, a generic computer system, a smart phone, a tablet PC, or any system that can process input commands.

In one embodiment, the AI module can store a set of predetermined component behavioral actions. These component actions can be acted independently or in combination by the robotic system 100 to produce complex outcomes. The outcome behavior of the robotic system 100 can be configured and/or altered according to the operator and/or the task to be performed by the robotic system 100.

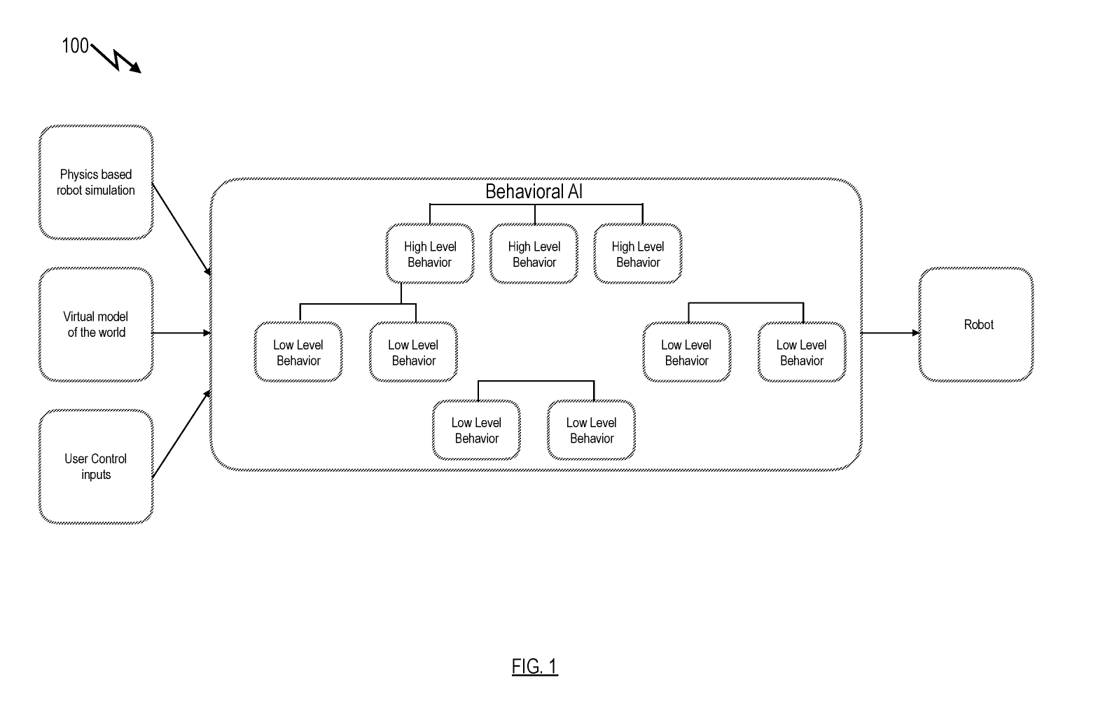

FIG. 1 presents a block diagram illustrating the operation of an exemplary AI module for integrating human input and autonomous behavior of a robotic system, in accordance with one embodiment of the present invention. In this example, the behavioral AI module (center block) takes as inputs (1) physical constraints of the robotic system 100, which can be obtained based on simulation of the robotic system 100; (2) a virtual model of the world (e.g., the environment in which the robotic system 100 operates); and (3) user control inputs.

The first set of input, the physical constraints of the robotic system 100, can be specific to the particular robotic system that the AI module is configured to control. This information can be obtained based on testing or simulation of the robotic system 100. In one embodiment, this constraint information can be obtained from the manufacturer of the robotic system 100. Information included in these constraints can include limits of the speed, altitude, operation temperature, and residual battery/fuel level.

The second set of input, the virtual model of the world, can be a data structure describing the physical conditions under which the robotic system 100 operates. For example, if the robotic system 100 is a drone, the virtual model of the world can include models of the buildings and obstacles in the space where the drone will carry out a flight. This virtual model of the world can be downloaded from the cloud based on the current location of the drone, or be constructed based on a local survey using, for example, one or more cameras.

The third set of input, the user control inputs, can be one or more user commands indicating the user-desired operation to be performed by the robotic system 100. For example, the user might instruct a drone to survey a building by flying in a certain route.

In one embodiment, the AI module can store a number of low-level component behavioral actions, which can serve as the building block for constructing more complex operations. In one embodiment, the AI module can implement a hierarchical behavior construction scheme, in which low-level component actions can be combined to form high-level behavioral actions.

During operation, when the AI module receives user control inputs, the AI module can determine whether the user-desired operation can comply with the virtual model of the world and the physical constraints of the robotic system 100. If the user control inputs cannot comply with these limits, the AI module can alter the user control input, using the stored low-level component actions and high-level behaviors, such that the modified user inputs can lead to an operation that can be performed by the robotic system 100. The AI module can then send the modified commands to the robotic system 100, which in turn performs a series of operations accordingly.

For example, when a user inputs a command to instruct a drone to fly 50 yards at 15 miles/hour in a given direction, and the AI module determines that there is a wall at 45 yards, the AI module can modify the user command such that the drone will fly at 15 miles/hour for the first 30 yards, decelerate for the next 10 yards, and stop or change its direction of travel at 5 yards from the wall.

In some embodiments, the modified user-operation can result in a set of preplanned, completely autonomous actions for the robotic system 100.

In some embodiments, the system can apply limits on the human input to produce acceptable actions, such as hard-stop limits, maximum or minimum values of certain parameters for the robotic system 100 (e.g., distance, altitude, speed, etc.).

In some embodiments, the system can limit the number of commands the user can issue to reduce the likelihood of error.

In some embodiments, the system can accept user input actions that are guaranteed to be performed by the robotic system 100 in unchanging conditions.

The description above is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer- readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

### 2. First Variation

In this disclosure, the term “robot” can refer to any electrical, mechanical, or combined system, which can perform operations in a partially or fully automated fashion. Robots can include a stand-alone system or part of a large system. Robots can include, but are not limited to, drones, land surface vehicles, water surface vehicles, submarines, and subterranean vehicles or machines.

At present, robots are increasingly being used to perform tasks that were once performed by humans. Often, a robot is configured to “auto-pilot” in an unknown environment, where collision could occur. Current collision detection and avoidance technology, however, suffers from problems caused by narrow field of view of single sensors, high latency, and insufficient accuracy. Users operating robots with sense-and-avoid technology are often given a false sense of confidence, believing that the robot is crash proof, when in reality it is only crash resistant. This could lead to crashing the robot, because the human operator can be overconfident in the robot's ability to automatically avoid collision. In addition, users of these robots often desire accurate and real-time information about the environment in which the robot operates.

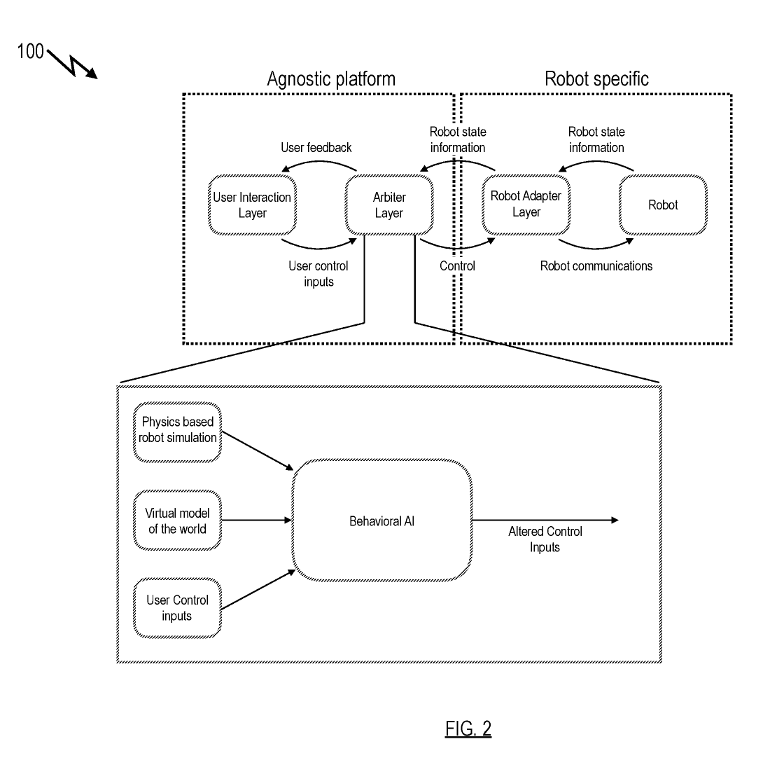

As shown in FIG. 2, embodiments of the present invention solve the aforementioned problem by constructing a model of the environment in which the robot operates by using sensors on the robot. This system can construct this model of the environment in real time. In some embodiments, the system receives real-time, depth-sensing information of the environment, and correlates this information to a location in an inertial space, which in turn allows the system to create a 3-D map of objects in the space as the robot moves through the environment. Over time, as more data is collected by the system, the map can become progressively more representative of the physical world.

In addition, a prediction module can use this model of the environment to predict potential collisions based on the robot's physical movement. The robot can then use both the real-time sensor information collected by the on-board depth sensors and the previously constructed environment model to navigate itself while avoiding collisions. This collision avoidance mechanism is not limited by the field of view of the on-board sensors, does not suffer from lower latency, and has better accuracy. Furthermore, this environment model and depth information can be used to display real-time measurements and information about the environment in which the robot operates. The computation of this environment model and collision avoidance can be done with a combination of onboard and remote computational resources.

In some embodiments, the robot can have multiple sensors which provides a 360-degree field of view.

In some embodiments, data collected by the on-board sensors can be fused into the environment model to produce a complete world model in real time.

In some embodiments, the system can decrease the speed at which the robot moves, so that the available processing power is sufficient to generate the environment model.

In some embodiments, the system can display depth information provided by collision-detection sensors to allow a human operator to instruct the robot to avoid collision.

In some embodiments, offline (e.g., cloud-based) processing can be used which to stitch together large batches of sensor data to make measurable 3D models of the environment.

Note that once the environment model is established, the data structure representing the environment can be stored in the robot. When the robot's current location is calibrated to match a corresponding location in the environment model, the robot can move in the space and avoid collisions without any real-time sensor input by using an internal inertia-based navigation system. Such inertia-based navigation system can include a gyroscope, one or more accelerometers, or a combination thereof.

The description above is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system.

The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer- readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention

### 3. Second Variation

In this disclosure, the term “robot” can refer to any electrical, mechanical, or combined system, which can perform operations in a partially or fully automated fashion. Robots can include a stand-alone system or part of a large system. Robots can include, but are not limited to, drones, land surface vehicles, water surface vehicles, submarines, and subterranean vehicles or machines.

At present, robots are increasingly being used to perform tasks that were once performed by humans. The types of tasks for which organizations use robots can vary and often require specialized equipment for the task. The use of various robot models from different manufactures leads to segmentation of the software needed to properly deploy the robots, despite the fact that high-level tasks can be very similar. Without a unified software platform, operators are often required to learn the ins and outs of each robot, which can lead to high training cost, high software maintenance cost, knowledge segmentation, and the need to purchase multiple software licenses. The training burden in these situations can be high, and could prevent adoption of new robotics technologies.

Embodiments of the present invention solve the aforementioned problems by a robot-agnostic control platform for controlling a variety of robots. This robot-agnostic control platform can be based on software, and can control a variety of robot types and sensors regardless of manufacturer. A centralized portion of the robot-agnostic control platform is an arbiter module, which maintains the system functionality and high level parameters that are not specific to a particular type of robot or sensor. The system also provides an adapter module for a specific type of robot or sensor. During operation, the arbiter module sends commands to the robot- or sensor-specific adapter. The corresponding adapter translates the commands into robot- or sensor-specific format and handles all direct communication with the robot or sensor. In addition, the adapter can receive data from the robot or sensor, translate the data into a generalized format, and send the translated data to the arbiter, thereby completing the information and control loop.

In some embodiments, the system can include an interface or a piece of software that can stitch together multiple independent robot or sensor control frameworks into one package.

In some embodiments, the system can include a common control protocol, by which different types of robots can “speak the same language.”

The description above is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer- readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed.

Accordingly, many modifications and variations will be apparent to practitioners skilled in the art. Additionally, the above disclosure is not intended to limit the present invention.

### 4. Third Variation

In this disclosure, the term “robot” can refer to any electrical, mechanical, or combined system, which can perform operations in a partially or fully automated fashion. Robots can include a stand-alone system or part of a large system. Robots can include, but are not limited to, drones, land surface vehicles, water surface vehicles, submarines, and subterranean vehicles or machines.

At present, robots are increasingly being used to perform tasks that were once performed by humans. Often, a robot is configured to move autonomously in a 3-D space. For example, a drone can be programmed to fly a certain route to survey an area. In general, there are often multiple 3-D geometry policies, such as denied zones and allowed zones, with which the robot is expected to comply. Dealing with such 3-D geometry policies can present a challenge in terms of computational feasibility, and can also confuse a human operator. When a robot interacts with these zones, the goal is for the robot to behave optimally by respecting these zones, some of which may overlap with one another. This is useful for regulatory compliance, safety, organization, and optimized traversal through spaces.

As shown in FIG. 3, embodiments of the present invention solve the problem of enforcing 3-D geometry policies during a robot's traversal of a space by representing different zones as “force fields.” A zone where traversal is forbidden or undesired can be represented as a field with a force source, that is, a source of force that rejects any object present in the zone. A zone where traversal is permitted can be represented as a field with a force sink, that is, a source of force that draws any object in or near the zone.

An operator or programming module (such as an artificial intelligence engine) can test the different zones by logically “pushing” against the boundaries of these zones in this model. A respective zone might “push back” depending on the logic and configuration of the model. This approach can create an interactive experience and allow the system to explore the space with the robot while respecting the policies associated with different zones. This model can also be computationally faster and easier to implement than other techniques.

In some embodiments, data associated with the configuration of various force-field zones can be obtained from human input, a 3-D model, or data obtained by sensors. It can also be generated based on artificial intelligence. By presenting a display of the combined effect of all the zone forces, the system or operator can see what the robot is and is not allowed to do in a 3-D space. In one embodiment, the system can produce a continuous influence on the robot's position, which can be independent of the specific zones creating the behavior.

In some embodiments, the force in each field can represent the level of enforcement for the corresponding zone. For example, for an FAA no-fly zone, the pushing force value can be set to be a very large value or infinity. For a zone that is in the vicinity of a hazardous object such as power lines, the force value can be set to a moderately high value. For a zone that is in the vicinity of a benign object such as a tree, the force can be set to an intermediate value.

The figure above illustrates one example. The two circles represent 3-D zones where the robot is not allowed to enter. Each such zone is a force field with a source in the middle that produces a rejecting force (indicated by arrows pointing away from the center of the zone). The rectangle above represents a 3-D zone where the robot is allowed to enter. This zone is a force field with a sink in the middle, which produces a drawing force (indicated by arrows pointing toward the center the zone). Assume a robot (represented as a black square) is in an area where the three zones overlap. The joint effect of the two disallowed zones (i.e., the two circles), combined with the drawing force of the allowed zone, would produce a force pushing the robot toward the allowed zone. Assume further that the robot is on the top right position within the circle on the right, the rejecting force of this zone would push the robot out of the circle. In addition, the drawing force in the rectangular would pull the robot into the allowed zone.

In some embodiments, the system can plan the future path of the robot in advance and check that it complies with all the 3-D geometry policies. In further embodiments, the system can also apply a sample-based planning algorithm to check possible future states and decide on allowed directions of motion based on these sampled states.

In this implementation, the robotic system 100 can execute method for facilitating compliance with 3-D geometry policies, including: representing an allowed 3-D zone as a virtual pulling force field, wherein the allowed zone allows a robot to be present therein, and wherein the pulling force field produces a virtual pulling force, thereby drawing a robot; and representing a disallowed 3-D zone as a virtual pushing force field, wherein the disallowed zone disallows or discourages a robot to be present therein, and wherein the pushing force field produces a virtual pushing force, thereby rejecting a robot. The robotic system 100 can further: display the virtual pulling force field and pushing force field, thereby allowing an operator or system to identify the corresponding 3-D geometry policies. The robotic system 100 can also sett an amount of force in a respective force field based on a level of enforcement associated with the corresponding 3-D geometry policy.

The description above is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer- readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for facilitating integration of user input and autonomous operations of a robotic system, the method comprising: storing a set of constraints of the robotic system; storing a model of an environment in which the robotic system 100 is to operate; determining whether the robotic system can successfully perform operations specified by a user based on the constraints of the robotic system and the model of the environment; and, in response to determining that the robotic system cannot successfully perform the operations, modifying the operations so that the modified operations can be performed by the robotic system; and generating a set of commands for the robotic system based on the modified operations.

2. The method of claim 1, further comprising: storing a set of low-level component actions which can be performed the robotic system; and constructing high-level behaviors for the robotic system using the low-level component actions.

3. The method of claim 2, wherein modifying the user-specified operations comprises modifying the user-specified operations using a low-level component action, a high-level behavior, or a combination thereof.

4. A method for facilitating collision avoidance for a robot, the method comprising:
constructing a model of an environment in which the robot operates, based on depth-sensing sensor data collected by on-board sensors of the robot and inertia-based navigation information collected by the robot; determining whether a collision is likely to occur based on the model of the environment, a current location of the robot, and movement information of the robot; and, in response to determining that a collision is likely to occur, issue a command to the robot, thereby allowing the robot to change its course of movement to avoid the collision.

5. The method of claim 4, wherein determining whether the collision is likely to occur comprises using an inertia-based navigation system to obtain the current location and movement information of the robot.

6. The method of claim 4, wherein determining whether the collision is likely to occur comprises using data collected by on-board depth-sensing sensors to obtain the current location and movement information of the robot.

7. A system for facilitating a robot- and sensor-agnostic control platform for controlling different types of robots and sensors, the system comprising: an arbiter module configured to maintain a set of system functions and high-level behavior information, which are not specific to a particular type of robot or sensor; and at least one adapter module that is specific to one type of robot or sensor, the adapter module being coupled to the arbiter module; wherein the arbiter module is further configured to send robot- or sensor-agnostic commands to the adapter module; and
wherein the adapter module is further configured to translate the robot- or sensor-agnostic commands into robot- or sensor-specific commands, thereby allowing the arbiter module to be programmed in a robot- or sensor-agnostic manner.

8. The method of claim 7, wherein the adapter module is further configured to receive robot- or sensor-specific data and convert the received data into a generalized format that is not specific to a particular type of robot or sensor.
